(19) United States
(12) Patent Application Publication
(10) Pub. No.: US 2009/0310723 A1
(43) Pub. Date: Dec. 17, 2009

(54) AUTOMATIC GAIN CONTROL CIRCUIT

(76) Inventor: Kazuhisa Ishiguro, Ota-shi (JP)

Correspondence Address: SMITH PATENT OFFICE, 1901 PENNSYLVANIA AVENUE N W, SUITE 901, WASHINGTON, DC, 20006, US

(21) Appl. No.: 12/306,687

(22) PCT Filed: Feb. 6, 2007
(86) PCT No.: PCT/JP2007/052443

§ 371 Date: Dec. 24, 2008

(30) Foreign Application Priority Data
Jun. 27, 2006 (JP) 2006-176149

(51) Int. Cl. H04L 27/08

(52) U.S. Cl. 375/345

(57) ABSTRACT

Circuits (an AGC amplifier 8 and a second A/D converting circuit 9) for detecting an antenna level of a disturbing wave are provided on an output of a frequency converting circuit 4, and levels of antenna ends of a desirable wave and the disturbing wave are calculated by a DSP 10 and a gain of an antenna damping circuit 2, an LNA 3 or the frequency converting circuit 4 is adjusted corresponding to the respective levels, thereby enabling an optimum gain distribution for an RF stage to be set corresponding to the levels of the desirable wave and the disturbing wave.

### FIELD OF THE INVENTION

The present invention relates to an automatic gain control circuit, and more particularly to a circuit for carrying out an AGC operation to suppress a distortion of a signal when a strong signal is input to a wireless communicating apparatus such as a radio receiver.

### DESCRIPTION OF THE RELATED ART

A wireless communicating apparatus such as a radio receiver is usually provided with an AGC (Automatic Gain Control) circuit for adjusting a gain of a received signal. An RF (Radio Frequency) AGC circuit adjusts a gain of a radio frequency signal (an RF signal) received by an antenna and maintains a level of the received signal to be constant. The RF-AGC can be implemented by controlling a quantity of attenuation in an antenna damping circuit or a gain of an LNA (Low Noise Amplifier) or the like.

The RF-AGC circuit is not operated when an electric field strength of an antenna input signal is not greater than a threshold, and does not reduce the gain of the received signal. However, when a signal having a strong electric field is input to an antenna so that the electric field strength exceeds the threshold, the RF-AGC circuit is operated to reduce the gain of the received signal, thereby preventing an excessive power from being applied to the wireless communicating apparatus.

Conventionally, there has been proposed a technique for executing AGC processings of an antenna damping circuit and an LNA as digital signal processings by using a DSP (Digital Signal Processor) (for example, see Patent Document 1). In the technique described in the Patent Document 1, a level of a broadband RF signal which is output from the LNA, a level of a middle band intermediate frequency signal (IF signal) which is output from an IF (Intermediate Frequency) amplifier and a level of a narrowband IF signal which is output from an IF filter are detected respectively and are converted into digital signals, and the DSP determines a possibility of a gain adjustment of the antenna damping circuit and the LNA and a quantity of the gain adjustment based on a signal level of each band.

Patent Document 1: WO2005/053171 Publication

FIG. 1 is a diagram showing a structure of a conventional radio receiver which carries out AGC processings of an antenna damping circuit and an LNA by using a DSP. In FIG. 1, an RF signal received through an antenna 101 is supplied to a frequency converting circuit 104 via an antenna damping circuit 102 and an LNA 103. By the frequency converting circuit 104, the RF signal supplied from the LNA 103 and a local oscillating signal supplied from a local oscillating circuit which is not shown are mixed so that an IF signal is generated through a frequency conversion. The IF signal output from the frequency converting circuit 104 is subjected to a band limitation in a BPF 105 and is thus changed into a narrowband IF signal including only one station of a desirable frequency.

The narrowband IF signal output from the BPF 105 is amplified by an IF amplifier 106 and is then subjected to an analog/digital conversion through a first A/D converting circuit 107 so that digital data are obtained. The narrowband digital IF signal thus obtained is input to a DSP 111. The DSP Ill carries out a processing for demodulating the narrowband digital IF signal input from the first A/D converting circuit 107 into a baseband signal, and the baseband signal thus obtained is output to an outside.

A broadband RF signal (a signal containing both a desirable wave and a disturbing wave) output from the LNA 103 is also supplied to a detecting circuit 108. For an RF-AGC processing, a level of the broadband RF signal is then detected by the detecting circuit 108 so that the level of the RF signal and a predetermined threshold are compared with each other by a comparator 109. A signal indicative of a relationship between the detected level of the RF signal and the predetermined threshold is output from the comparator 109. Furthermore, a signal output from the comparator 109 is converted into a digital signal through a second A/D converting circuit 110 and the digital signal is supplied to the DSP 111.

Subsequently, an AGC signal is generated by the DSP 111 based on the digital signal sent from the second A/D converting circuit 110, and is supplied to a D/A converting circuit 112. The AGC signal changed into an analog signal by the D/A converting circuit 112 is supplied to the antenna damping circuit 102 or the LNA 103 through an interface circuit 113 so that a quantity of attenuation in the antenna damping circuit 102 or a gain of the LNA 103 is controlled. Thus, gains of the antenna damping circuit 102 and the LNA 103 are controlled on an analog basis through the DSP 111, the D/A converting circuit 112 and the interface circuit 113 in such a manner that the level of the RF signal converges on a threshold which is preset to the comparator 109.

A level of the signal detected by the detecting circuit 108 is equivalent to a level of the broadband RF signal containing both a desirable wave and a disturbing wave. For this reason, it is impossible to distinguish whether the detected level is possessed by the desirable wave or the disturbing wave. Therefore, a value set to prevent the RF signal from being distorted in an input of only the desirable wave is generally used for the threshold of the comparator 109. In other words, the threshold of the RF-AGC is set to be optimum for the level of the desirable wave.

On the other hand, the IF signal output from the IF amplifier 106 is converted into a digital signal through the first A/D converting circuit 107 and the digital signal is supplied to the DSP 111 so that the level of only the desirable wave can be detected by the DSP 111. In the radio receiver shown in FIG. 1, the level of the desirable wave is compared with the predetermined value in the DSP 111 and an RSSI (Received Signal Strength Indicator) signal is output to properly control the quantity of attenuation in the antenna damping circuit 102 and the gain of the LNA 103 when the level of the desirable wave is lower than the predetermined value.

If the RSSI signal is not present, the RF-AGC circuit is operated to reduce the gain of the RF signal in response to the signal supplied from the second A/D converting circuit 110 when the level of the desirable wave is lower than the predetermined value and the level of the disturbing wave is higher than the predetermined value. In this case, the gain of the desirable wave is also reduced together with the disturbing wave so that an originally low level is further reduced. For this reason, there is a problem in that a desirable receiving sensitivity cannot be taken due to a suppression in a sensitivity. On the other hand, in the case in which the RSSI signal is used, a control is carried out in such a manner that the gain of the RF signal is not decreased to be equal to or smaller than a certain value even if the level of the disturbing wave is higher than the predetermined value when the level of the desirable wave is lower than the predetermined value. Consequently, it is possible to avoid the problem of the suppression in a sensitivity.

### DISCLOSURE OF THE INVENTION

As described above, in the conventional automatic gain control circuit shown in FIG. 1, the threshold of the comparator 109 is set to be optimum for the level of the desirable wave. In this case, when only the desirable wave is particularly input, it is possible to control the gain so as to prevent the receiving sensitivity from being deteriorated and to inhibit a distortion from occurring on the RF signal.

In the conventional automatic gain control circuit, however, the threshold of the AGC is set to be optimum for the desirable wave and an optimum gain cannot be set to the disturbing wave. For this reason, when the disturbing wave is also input together with the desirable wave, it is hard to optimally control the gain of the RF signal without deteriorating the receiving sensitivity. In particular, there is a problem in that an intermodulation distortion characteristic is deteriorated and a desirable receiving sensitivity cannot be obtained when a two-signal disturbing wave (disturbing waves contained in two signals having close frequencies to each other) is input.

In the case in which there is utilized a technique for controlling the AGC operation by using the RSSI signal in order to eliminate a drawback that a suppression in the sensitivity is caused by the AGC operation through the disturbing wave when the level of the desirable wave is smaller than the predetermined value, the level of the RSSI signal is changed in a variation in the gain of the RF signal. For this reason, there is a problem in that an optimum gain of the RF signal cannot be set when the disturbing wave is received.

In order to solve the problems, it is an object of the present invention to enable an optimum gain for an RF-AGC circuit to be set when a disturbing wave is received. In particular, it is an object of the present invention to enable an improvement in an intermodulation distortion characteristic made when a two-signal disturbing wave is input, thereby obtaining a desirable receiving sensitivity.

In order to attain the objects, the present invention includes a level detecting portion for detecting a level of a desirable wave frequency and that of a disturbing wave frequency, a table information storing portion for storing table information which causes the level detected by the level detecting portion to correspond to a gain of a received signal which is to be adjusted by a gain adjusting portion, and a control portion for referring to the table information based on the level detected by the level detecting portion, thereby controlling the adjustment of the gain of the received signal through the gain adjusting portion.

According to the present invention having the structure described above, whether the gain adjustment of the received signal is to be carried out is decided based on the signal level of the desirable wave frequency and that of the disturbing wave frequency which are detected for the received signal, a degree at which the gain is to be adjusted is decided intelligently based on the table information by the control portion when the gain adjustment is carried out, and the gain is adjusted based on the result. Therefore, it is possible to optimally set the gain of the received signal when the disturbing wave is received. In particular, it is possible to considerably improve an intermodulation distortion characteristic made when a two-signal disturbing wave is input, thereby obtaining a desirable receiving sensitivity.

### BRIEF DESCRIPTION OF THE DRAWINGS

FIG. 1 is a diagram showing a structure of a conventional radio receiver for carrying out AGC processings of an antenna damping circuit and an LNA by using a DSP,

FIG. 2 is a diagram showing an example of the structure of the radio receiver executing an automatic gain control circuit according to the present invention,

FIG. 3 is a table showing an example of first table information according to the present embodiment,

FIG. 4 is a table showing an example of second table information according to the present embodiment,

FIG. 5 is a chart showing an intermodulation characteristic in an input of a two-signal disturbing wave to the radio receiver, and

FIG. 6 is a table showing an example of a control table to be used in the case in which a D/A converting circuit is disposed between a DSP and an interface circuit.

### BEST MODE FOR CARRYING OUT THE INVENTION

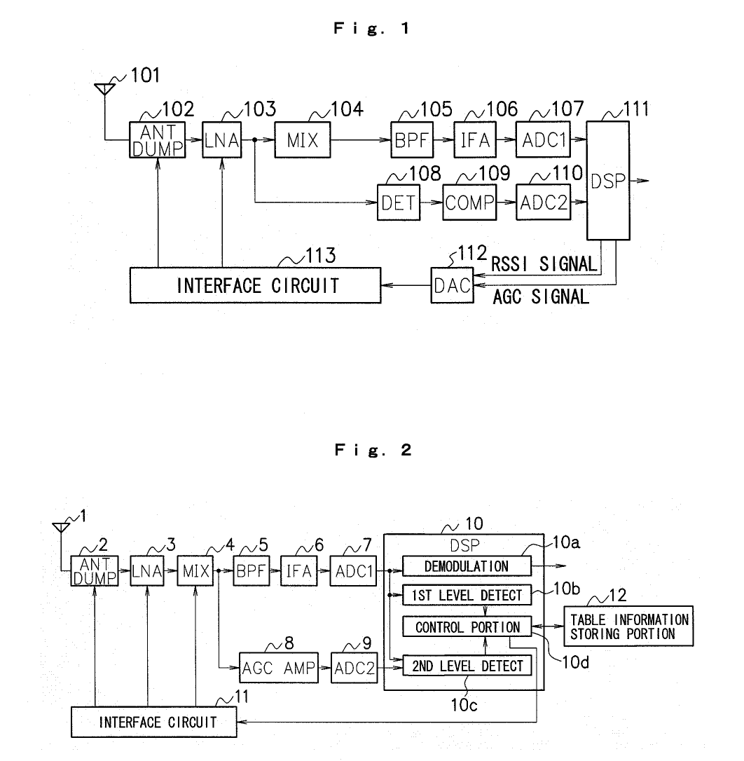

An embodiment according to the present invention will be described below with reference to the drawings. FIG. 2 is a diagram showing an example of a structure of a radio receiver executing an automatic gain control circuit according to the present invention. As shown in FIG. 2, the radio receiver according to the present embodiment includes an antenna 1, an antenna damping circuit 2, an LNA 3, a frequency converting circuit 4, a BPF 5, an IF amplifier 6, a first A/D converting circuit 7, an AGC amplifier 8, a second A/D converting circuit 9, a DSP 10, an interface circuit 11, and a table information storing portion 12. These structures (excluding the antenna 1) are integrated into a single semiconductor chip through a CMOS (Complementary Metal Oxide Semiconductor) process, for example.

The antenna damping circuit 2 controls an RF signal received through the antenna 1 (a comparatively broadband broadcast wave signal containing a desirable wave frequency and a disturbing wave frequency) to have an attenuation degree which is variably set in response to a control signal supplied from the interface circuit 11. The LNA 3 amplifies the RF signal passing through the antenna damping circuit 2 with a low noise. A gain of the LNA 3 is controlled in response to the control signal supplied from the interface circuit 11.

The signal amplified by the LNA 3 is supplied to the frequency converting circuit 4. The frequency converting circuit 4 mixes the RF signal supplied from the LNA 3 with a local oscillating signal supplied from a local oscillating circuit which is not shown, and carries out a frequency conversion to generate and output an IF signal. The frequency converting circuit 4 also has a gain adjusting function and the gain is controlled in response to the control signal supplied from the interface circuit 11.

A gain adjusting portion according to the present invention is constituted by the antenna damping circuit 2, the LNA 3 and the frequency converting circuit 4. The BPF 5 carries out a band limitation for the IF signal supplied from the frequency converting circuit 4, thereby extracting a narrowband IF signal containing only a desirable wave frequency.

The IF amplifier 6 amplifies the narrowband IF signal output from the BPF 5. The first A/D converting circuit 7 analog-digital converts the IF signal output from the IF amplifier 6. The narrowband digital IF signal thus converted into digital data is input to the DSP 10. The DSP 10 includes a demodulating portion 10a, a first level detecting portion 10b, a second level detecting portion 10c and a control portion 10d as a functional structure thereof. The demodulating portion 10a demodulates the narrowband digital IF signal input from the first A/D converting circuit 7 into a baseband signal and outputs the baseband signal.

The AGC amplifier 8 amplifies the broadband IF signal output from the frequency converting circuit 4. The second A/D converting circuit 9 analog-digital converts the IF signal output from the AGC amplifier 8. The broadband digital IF signal thus converted into digital data is input to the DSP 10.

The first level detecting portion 10b of the DSP 10 detects a receiving field strength of a desirable wave frequency contained in the signal received through the antenna 1 (an antenna level of a desirable wave) based on the narrowband digital IF signal input from the first A/D converting circuit 7. Moreover, the second level detecting portion 10c detects a receiving field strength of a disturbing wave frequency contained in the signal received through the antenna 1 (an antenna level of a disturbing wave) based on the narrowband digital IF signal input from the first A/D converting circuit 7 and the broadband digital IF signal input from the second A/D converting circuit 9.

Furthermore, the control portion 10d of the DSP 10 refers to table information (which will be described below in detail) stored in the table information storing portion 12 based on the antenna level of the desirable wave and that of the disturbing wave which are detected by the first and second level detecting portions 10b and 10c, thereby controlling an adjustment of a gain of a received signal through a gain adjusting portion in an RF stage (the antenna damping circuit 2, the LNA 3 and the frequency converting circuit 4).

More specifically, the control portion 10d refers to the table information, thereby generating control data for controlling the gain of the RF stage. Then, the control data are output to the interface circuit 11. The interface circuit 11 generates a control signal for controlling the gains of the antenna damping circuit 2, the LNA 3 and the frequency converting circuit 4 based on the control data supplied from the DSP 10 and supplies the control signal to the antenna damping circuit 2, the LNA 3 and the frequency converting circuit 4. Consequently, the gain of the received signal in the RF stage is controlled.

The interface circuit 11 includes a decoder for decoding the control data supplied from the control portion 10d and an analog switch which is controlled to be changed over based on an output of the decoder, and controls the gain of the received signal in the RF stage by changing over the analog switch. Because of the structure, the analog switch is directly controlled based on the table information stored in the table information storing portion 12 so that the gain of the RF stage can be controlled digitally.

Description will be given to a method of detecting the antenna level of the desirable wave and that of the disturbing wave through the DSP 10. First of all, an antenna level VD of the desirable wave can be obtained by a calculation expressed in the following (Formula 1).

VD=VIF0+Grf+Gif (Formula 1)
VIF0: an IF amplifier output level of a desirable wave
Grf: a total gain of the RF stage (the antenna damping circuit 2, the LNA 3 and the frequency converting circuit 4)
Gif: a gain of the IF amplifier 6

The IF signal input from the first A/D converting circuit 7 to the DSP 10 is a narrowband IF signal containing only a desirable wave frequency. By detecting a level of the IF signal input from the first A/D converting circuit 7 to the DSP 10 through the DSP 10, accordingly, it is possible to easily obtain the IF amplifier output level VIF0 of the desirable wave. Since the total gain Grf of the RF stage is a total of gains controlled by the DSP 10 itself and set to the antenna damping circuit 2, the LNA 3 and the frequency converting circuit 4 through the interface circuit 11, it is grasped by the DSP 10 itself. The gain Gif of the IF amplifier 6 is adjusted (IF-AGC) by the DSP 10 so as not to exceed a maximum input of the first A/D converting circuit 7, which is not shown. Therefore, the DSP 10 grasps the gain Gif of the IF amplifier 6.

On the other hand, the broadband digital IF signal input from the second A/D converting circuit 9 to the DSP 10 is a broadband IF signal containing both the desirable wave frequency and the disturbing wave frequency. Accordingly, a signal level VAGC is expressed in the following (Formula 2).

VAGC=√{(VD(Grf+Gagc))²+(VUD(Grf+Gagc))²} (Formula 2)
VUD: the antenna level of the disturbing wave
Gagc: the gain of the AGC amplifier 8

When two disturbing waves are present, the level VAGC of the broadband digital IF signal is obtained in accordance with the following (Formula 3). Disturbing wave levels of the two waves are set to be equal to each other.

VAGC=√{(VD(Grf+Gagc))²+2(VUD(Grf+Gagc))²} (Formula 3)

The gain of the AGC amplifier 8 has a fixed value. Therefore, it is possible to previously grasp the same gain in the DSP 10. If the level VAGC of the broadband digital IF signal and the IF amplifier output level VIF0 of the desirable wave are known from the (Formula 1) to the (Formula 3), accordingly, it is possible to obtain the antenna level VUD of the disturbing wave. As described above, the DSP 10 can easily obtain the IF amplifier output level VIF0 of the desirable wave by detecting the level of the IF signal input from the first A/D converting circuit 7. Moreover, the DSP 10 can easily obtain the level VAGC of the broadband digital IF signal by detecting the level of the IF signal input from the second A/D converting circuit 9.

As described above, by disposing the AGC amplifier 8 and the second A/D converting circuit 9 in an output stage of the frequency converting circuit 4 and providing a special signal path for detecting the antenna level of the disturbing wave, it is possible to obtain the antenna level VUD of the disturbing wave in accordance with the (Formula 2) or the (Formula 3).

Next, description will be given to the table information stored in the table information storing portion 12. The table information according to the present embodiment indicates a correspondence of the antenna level VD of the desirable wave and the antenna level VUD of the disturbing wave which are detected by the DSP 10 to the gain of the received signal which is to be adjusted by the gain adjusting portion of the RF stage. More specifically, the table information has first table information indicating a correspondence of the antenna level VD of the desirable wave to the gain of the received signal which is to be adjusted by the gain adjusting portion and second table information indicating a correspondence of the antenna level VD of the desirable wave and the antenna level VUD of the disturbing wave to the gain of the received signal which is to be adjusted by the gain adjusting portion.

The control portion 10d of the DSP 10 refers to either the first table information or the second table information based on the antenna level VD of the desirable wave and the antenna level VUD of the disturbing wave which are detected as described above, thereby controlling the adjustment of the gain of the received signal in the RF stage. More specifically, the adjustment of the gain of the received signal in the RF stage is controlled by referring to the first table information when the antenna level VUD of the disturbing wave is smaller than a predetermined value and referring to the second table information when the antenna level VUD of the disturbing wave is equal to or greater than the predetermined value.

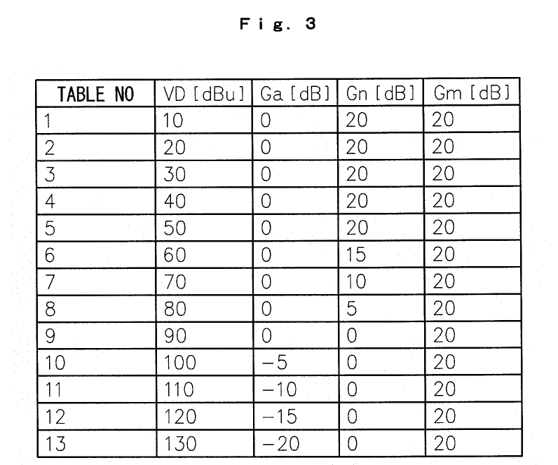

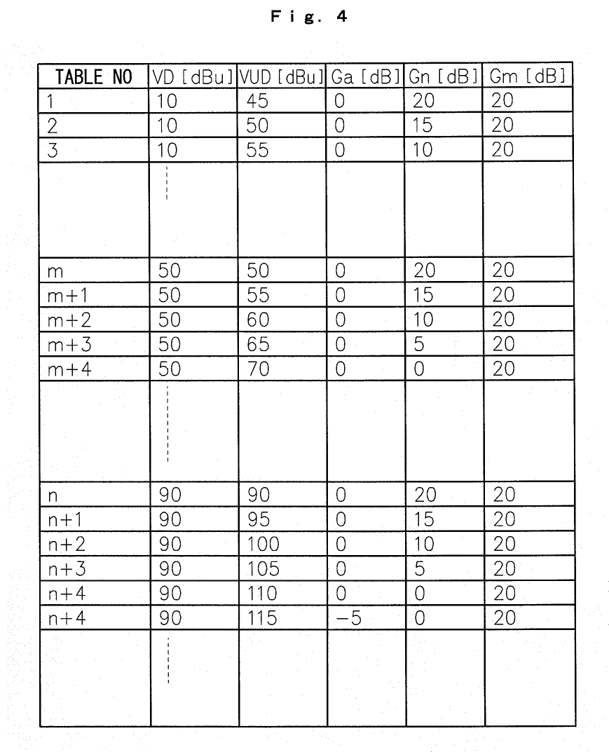

FIG. 3 is a table showing an example of the first table information. Moreover, FIG. 4 is a table showing an example of the second table information. For example, when the antenna level VUD of the disturbing wave is lower than a first predetermined value and the antenna level VD of the desirable wave is greater than a second predetermined value, a gain distribution list determined by the first table information illustrated in FIG. 3 is utilized. The control portion 10d sequentially controls a gain Ga of the antenna damping circuit 2, a gain Gn of the LNA 3 and a gain Gm of the frequency converting circuit 4 corresponding to the antenna level VD of the desirable wave based on the first table information, thereby improving an occurrence of a distortion of a received signal.

In the example of FIG. 3, when the antenna level VD of the desirable wave is equal to or higher than 60 [dBμ], the AGC is operated to control the gains of the antenna damping circuit 2, the LNA 3 and the frequency converting circuit 4. More specifically, when the antenna level VD of the desirable wave is 60 to 90 [dBμ], the received signal is first attenuated by the LNA 3. When the antenna level VD of the desirable wave is equal to or higher than 100 [dBμ], moreover, the quantity of attenuation is made insufficient even through a reduction in the gain of the LNA 3. For this reason, the gain is further reduced by the antenna damping circuit 2.

Although the gain of the frequency converting circuit 4 is not adjusted at all in the example of FIG. 3, it may be first controlled. An intermodulation distortion mainly occurs in the antenna 1 and the LNA 3. Depending on the structure of the system, however, the intermodulation distortion is improved by the adjustment of the gain of the frequency converting circuit 4 when the input level of the desirable wave is low.

By creating a list determining an optimum gain distribution for each stage corresponding to the antenna level VD of the desirable wave as the first table information shown in FIG. 3, it is possible to control an operation for setting an optimum gain through the antenna level VD of the desirable wave. Although the optimum gain distribution for each stage corresponding to the antenna level VD of the desirable wave can be set based on a simulation value, it is finally evaluated and determined by using an IC on which the circuit shown in FIG. 2 is mounted.

For example, when the antenna level VUD of the disturbing wave is higher than the first predetermined value, a problem of the intermodulation distortion is caused. In this case, the gain is adjusted by utilizing the gain distribution list determined by the second table information illustrated in FIG. 4. More specifically, the control portion 10d sequentially controls the gain Ga of the antenna damping circuit 2, the gain Gn of the LNA 3, and the gain Gm of the frequency converting circuit 4 corresponding to the antenna level VD of the desirable wave and the antenna level VUD of the disturbing wave based on the second table information, thereby improving the occurrence of the distortion of the received signal.

In the example of FIG. 4, when the antenna level VUD of the disturbing wave is equal to or higher than 50 [dBμ], the AGC is operated to control the gains of the antenna damping circuit 2, the LNA 3 and the frequency converting circuit 4 even if the antenna level VD of the desirable wave is low. For example, if the antenna level VD of the desirable wave is 50 [dBμ] and the antenna level VUD of the disturbing wave is 50 [dBμ], the gain Ga of the antenna damping circuit 2, the gain Gn of the LNA 3 and the gain Gm of the frequency converting circuit 4 are set to be Ga=0 [dB], Gn=20 [dB] and Gm=20 [dB], respectively. If a state of a field is changed to obtain VD=50 [dBμ] and VUD=70 [dBμ], the gain setting is controlled to obtain Ga=0 [dB], Gn=0 [dB] and Gm=20 [dB].

By creating a list determining an optimum gain distribution for each stage corresponding to the antenna level VD of the disturbing wave as the second table information shown in FIG. 4, it is possible to control an operation for setting an optimum gain through the antenna level VUD of the disturbing wave. Although the optimum gain distribution for each stage corresponding to the antenna level VUD of the disturbing wave can be set based on a simulation value, it is finally evaluated and determined by using an IC on which the circuit shown in FIG. 2 is mounted.

As described above in detail, in the present embodiment, the circuit for detecting the antenna level VUD of the disturbing wave is provided on the output of the frequency converting circuit 4 to calculate the levels VD and VUD on antenna ends of the disturbing wave in addition to the desirable wave through the DSP 10, thereby setting the gain of the antenna damping circuit 2, the LNA 3 or the frequency converting circuit 4 properly corresponding to the respective levels VD and VUD. Consequently, it is possible to set the optimum gain distribution for the RF stage corresponding to the levels of the desirable wave and the disturbing wave. Therefore, it is possible to optimize a noise and a distortion characteristic, thereby obtaining a desirable receiving sensitivity. It is possible to set an optimum gain distribution for the RF stage. Therefore, it is possible to particularly improve an intermodulation distortion characteristic made when a two-signal disturbing wave is input, thereby obtaining the desirable receiving sensitivity.

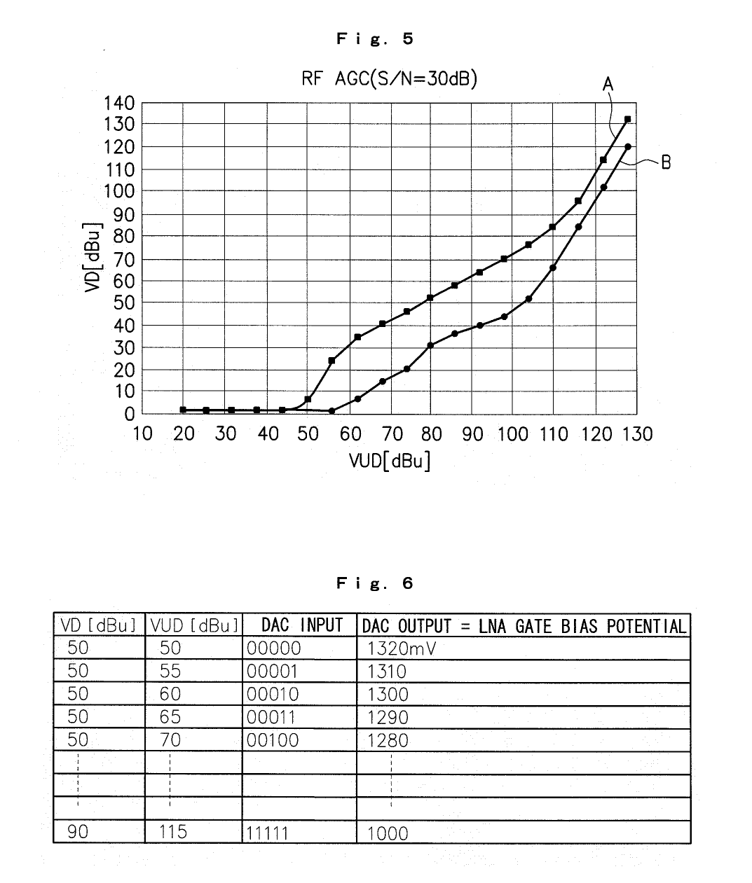

FIG. 5 is a chart showing an intermodulation characteristic made when a two-signal disturbing wave is input to a radio receiver. In FIG. 5, a graph shown in A indicates an intermodulation characteristic made when the two-signal disturbing wave is input to the conventional radio receiver illustrated in FIG. 1. Moreover, a graph shown in B indicates an intermodulation characteristic made when the two-signal disturbing wave is input to the radio receiver according to the present embodiment illustrated in FIG. 2. There are shown levels of a desirable wave and a disturbing wave in the case in which S/N of an FM demodulating output can be maintained to be 30 [dB].

For example, when the antenna level VUD of the disturbing wave is 100 [dBμ], an input level of the desirable wave is to be approximately 72 [dBμ] or more in an RF-AGC using a conventional method in order to maintain S/N of 30 [dB]. On the other hand, in the RF-AGC according to the present embodiment, it is possible to maintain S/N of 30 [dB] at a desirable wave input level of approximately 46 [dBμ].

In the example of FIG. 4, also when the antenna level VD of the desirable wave is low, that is, 10 [dBμ] and the antenna level VUD of the disturbing wave is equal to or higher than 50 [dBμ], the gain Gn is of the LNA 3 is decreased. This is set based on the simulation value and is a gain distribution example in which the S/N can be maintained to be 30 [dB]. Conventionally, the gain of the RF stage is controlled on an analog basis. When the gain of the RF stage is decreased with VD=10 [dBμ] and VUD=50 [dBμ] or more, therefore, the control is not guaranteed to converge on a point of S/N=30 [dB], and the gain of the RF stage is decreased, resulting in a deterioration in a sensitivity. On the other hand, in the present embodiment, the gain is controlled digitally. Therefore, it is possible to maintain S/N=30 [dB].

While the description has been given to the example in which the gain of the RF stage is set by using the table information shown in FIGS. 3 and 4 in the embodiment, the present invention is not restricted thereto. For example, the first table information shown in FIG. 3 may be added to the second table information shown in FIG. 4 to obtain single table information. Since the second table information sets the gains for the antenna levels VD and VUD of the desirable wave and the disturbing wave, it is complicated. For the case in which the antenna level VUD of the disturbing wave having a high using frequency is lower than the first predetermined value in the AGC control, it is preferable to prepare the simple table shown in FIG. 3. If a variable threshold corresponding to the antenna level of the desirable wave or that of the disturbing wave can be set into an AGC loop, moreover, it is not necessary to always use the table information.

Although the digital AGC signal output from the DSP 10 is directly input to the interface circuit 11 in the embodiment described above, furthermore, the present invention is not restricted thereto. For example, a D/A converting circuit may be disposed between the DSP 10 and the interface circuit 11. In the case in which a 5-bit D/A converting circuit is used to control a gate bias potential of the LNA 3, for example, the gain of the LNA 3 can be controlled in a resolution in 32 stages. In this case, the interface circuit 11 includes a threshold determining circuit for determining a threshold of the AGC of the LNA 3 based on a signal output from the D/A converting circuit. Thus, if the threshold of the LNA 3 is changed to control the gain, it is possible to carry out a fine gain control. FIG. 6 shows an example of a control table in this case.

In case of the embodiment shown in FIG. 2, the analog switch is used for the interface circuit 11. For this reason, in the case in which a fine gain control of AM or the like is required, a large number of analog switches are required so that the interface circuit 11 is complicated. On the other hand, in case of a structure in which the D/A converting circuit is disposed between the DSP 10 and the interface circuit 11, a large number of analog switches are not required. Therefore, the interface circuit 11 can be simplified. On the other hand, in case of the embodiment shown in FIG. 2, the D/A converting circuit is not required but the gain of the RF stage can be directly controlled by the DSP 10. Therefore, there is an advantage that the system can be simplified.

Although the description has been given to the example in which the antenna damping circuit 2, the LNA 3 and the frequency converting circuit 4 are provided as the gain adjusting portions in the embodiment, moreover, it is not necessary to provide all of them. For example, only the antenna damping circuit 2 and the LNA 3 may be set to be the gain adjusting portions (the frequency converting circuit 4 is set to have a fixed gain).

In addition, the embodiment is only illustrative for a concreteness to carry out the present invention and the technical range of the present invention should not be construed to be restrictive. In other words, the present invention can be carried out in various forms without departing from the spirit or main features thereof.

### INDUSTRIAL APPLICABILITY

The present invention is useful for an automatic gain adjusting circuit to carry out an AGC operation for suppressing a distortion of a signal when a strong signal is input to a wireless communicating apparatus such as a radio receiver.

This application is based on Japanese Patent Application No. 2006-176149 filed on Jun. 27, 2006, the contents of which are incorporated hereinto by reference.

What is claimed is:

1. An automatic gain control circuit comprising:
a gain adjusting portion for adjusting a gain of a received signal;
a first level detecting portion for detecting a level of a desirable wave frequency contained in the received signal;
a second level detecting portion for detecting a level of a disturbing wave frequency contained in the received signal;
a table information storing portion for storing table information causing the levels detected by the first and second level detecting portions to correspond to the gain of the received signal which is to be adjusted by the gain adjusting portion; and
a control portion for referring to the table information based on the level of the desirable wave frequency which is detected by the first level detecting portion and the level of the disturbing wave frequency which is detected by the second level detecting portion, thereby controlling the adjustment of the gain of the received signal through the gain adjusting portion.

2. The automatic gain control circuit according to claim 1, wherein the table information storing portion stores first table information for causing the level of the desirable wave frequency which is detected by the first level detecting portion to correspond to the gain of the received signal which is to be adjusted by the gain adjusting portion, and second table information for causing the level of the desirable wave frequency which is detected by the first level detecting portion and the level of the disturbing wave frequency which is detected by the second level detecting portion to correspond to the gain of the received signal which is to be adjusted by the gain adjusting portion, and
the control portion refers to either the first table information or the second table information based on the level of the desirable wave frequency which is detected by the first level detecting portion and the level of the disturbing wave frequency which is detected by the second level detecting portion, thereby controlling the adjustment of the gain of the received signal through the gain adjusting portion.

3. The automatic gain control circuit according to claim 2, wherein the control portion controls the adjustment of the gain of the received signal through the gain adjusting portion by referring to the first table information when the level of the disturbing wave frequency which is detected by the second level detecting portion is lower than a predetermined value and referring to the second table information when the level of the disturbing wave frequency which is detected by the second level detecting portion is equal to or higher than the predetermined value.

4. The automatic gain control circuit according to claim 1, wherein the first level detecting portion, the second level detecting portion and the control portion are constituted by a digital signal processing portion.

5. The automatic gain control circuit according to claim 4, further comprising:
an amplifying circuit for amplifying a broadband intermediate frequency signal output from a frequency converting circuit for carrying out a frequency conversion processing for a received signal having a gain adjusted by the gain adjusting portion; and
an A/D converting circuit for converting the broadband intermediate frequency signal amplified by the amplifying circuit into a digital signal and supplying the digital signal to the digital signal processing portion.

6. The automatic gain control circuit according to claim 1, further comprising:
a decoder for decoding control data output from the control portion to control the adjustment of the gain of the received signal through the gain adjusting portion; and
an analog switch for controlling change-over based on an output of the decoder,
the gain of the received signal through the gain adjusting portion being controlled by changing over the analog switch.

7. The automatic gain control circuit according to claim 1, further comprising:
a D/A converting circuit for converting, into an analog signal, control data output from the control portion to control the adjustment of the gain of the received signal through the gain adjusting portion; and
a threshold determining circuit for determining a threshold of a gain control in the gain adjusting portion based on a signal output from the D/A converting circuit,
the threshold being changed to control the gain of the received signal through the gain adjusting portion.
